(19) United States
(12) Patent Application Publication
(10) Pub. No.: US 2026/0321098 A1
(43) Pub. Date: Oct. 15, 2026

(54) GAMING SYSTEM AND METHOD WITH SPIN-HOLD-MATCH FEATURE

(71) Applicant: LNW Gaming, Inc., Las Vegas, NV (US)

(72) Inventor: Paul CLARKE, Birmingham (GB)

(21) Appl. No.: 19/703,346

(22) Filed: Jun. 10, 2026

Related U.S. Application Data
(63) Continuation of application No. 17/966,137, filed on Oct. 14, 2022.

(51) Int. Cl. G07F 17/32; G07F 17/34

(52) U.S. Cl. CPC G07F 17/3267; G07F 17/3213; G07F 17/3244; G07F 17/34

(57) ABSTRACT

A gaming system includes a gaming cabinet, a presentation assembly, and game-logic circuitry secured within a locked box inside the cabinet. Prior to executing a wagering game, the game-logic circuitry runs an authentication program that compares a live code derived from memory contents to a trusted code stored in memory and gates execution of the random number generator and outcome-determining programming. During a base game, a persistent-element state record is held in memory across wagering game cycles and is updated and transformed into animation control signals when a bonus-triggering symbol lands; execution of the trigger-determining random number generator is forgone when no bonus-triggering symbol lands. On bonus-game trigger, a game-state data record drives selective respin of vacant-position reels and award of prizes from the landed prize symbols.

### CROSS-REFERENCE TO RELATED APPLICATION

This application is a continuation of U.S. patent application Ser. No. 17/966,137, filed Oct. 14, 2022. The disclosure of U.S. patent application Ser. No. 17/966,137 is hereby incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2022-2026, LNW Gaming, Inc.

### FIELD OF THE INVENTION

The present invention relates to a technological improvement to gaming systems, gaming machines, and methods and, more particularly, to technological improvements in connection with a spin-hold-match feature.

### BACKGROUND OF THE INVENTION

The gaming industry depends upon player participation. Players are generally “hopeful” players who either think they are lucky or at least think they can get lucky-for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present invention, there is provided a gaming machine and method that utilize a presentation assembly configured to present a plurality of reels, an array, and a prize board. The reels bear prize symbols. The prize board includes prizes and associated collection registers. The prize symbols are associated with respective ones of the prizes. Game-logic circuitry is configured to spin and stop the reels to land symbols from the reels in the array and update the register for the prize that is associated with any landed prize symbol. In response to none of the updated registers being filled, the game-logic circuitry is configured to hold the landed prize symbols in place in the array and repeat the above operations until any of the updated registers are filled, at which time the prizes associated with the filled registers are awarded.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3A and 3B are a flow diagram for a data processing method that corresponds to instructions executed by a controller, according to an embodiment of the present invention. FIG. 3A relates to a base-game portion of a wagering game; FIG. 3B relates to a bonus game that may be triggered during play of the base game.

FIG. 4 is an exemplary presentation of a base-game spin outcome resulting from the flow diagram in FIG. 3A.

FIGS. 5-7 are exemplary presentations of bonus-game spin outcomes resulting from the flow diagram in FIG. 3B.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

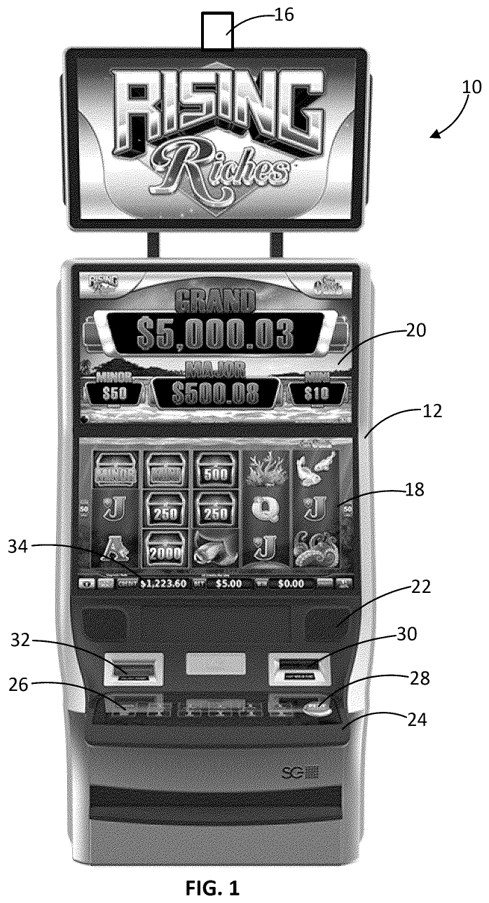

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots with physical symbol-bearing reels, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) mounted over the primary or secondary presentation devices, an input deck 24 supporting a video button panel 26 bearing touch keys and one or more mechanical push-buttons 28, a bill/ticket acceptor 30, a card reader/writer (not shown), a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, video button panel 26, push-buttons 28, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credit” meter 34. The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 30, a card reader/writer (not shown), a wireless communication interface for reading cash or credit data from a nearby mobile device, and a network interface for withdrawing cash or credits from a remote account via an electronic funds transfer. In response to a cashout input that initiates a payout from the credit balance on the “credit” meter 34, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, a card reader/writer, the ticket dispenser 32 for printing tickets redeemable for cash or credits, a wireless communication interface for transmitting cash or credit data to a nearby mobile device, and a network interface for depositing cash or credits to a remote account via an electronic funds transfer.

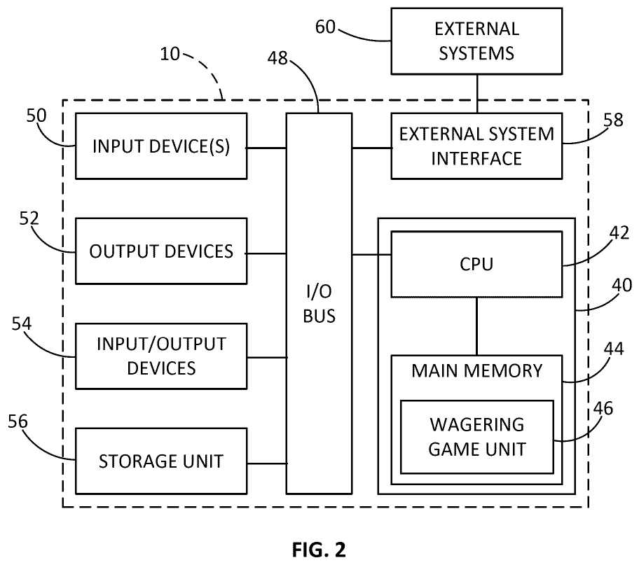

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S. A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

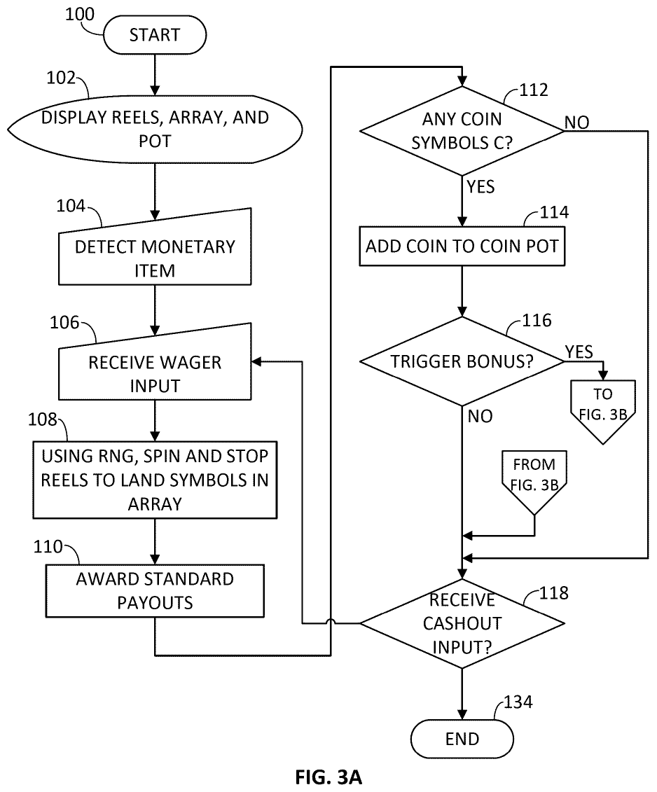

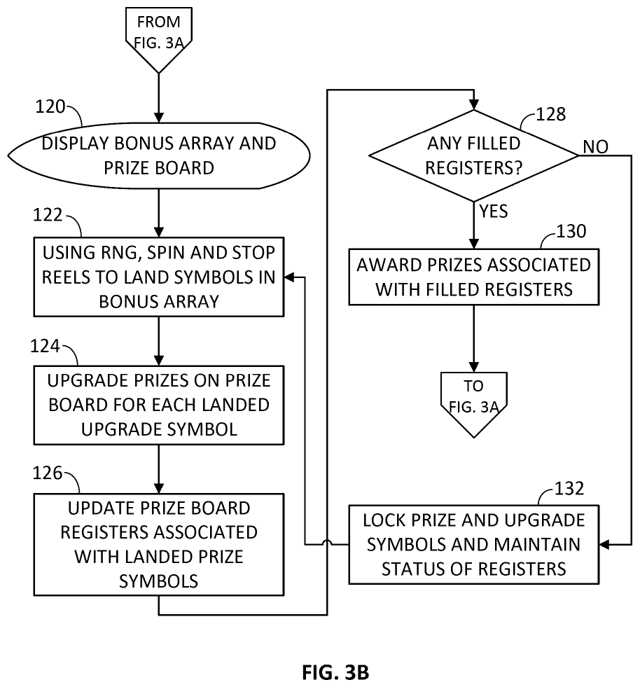

Referring now to FIGS. 3A-3B, there is shown a flow diagram representing one data processing method corresponding to at least some instructions stored and executed by the game-logic circuitry 40 in FIG. 2 to perform operations according to an embodiment of the present invention. The data processing method is described below in connection with the exemplary presentations of spin outcomes in FIGS. 4-7.

Referring to FIG. 3A, the data processing method commences at step 100. At step 102, the game-logic circuitry controls one or more presentation devices (e.g., mechanical-reel display device, video display device, or a combination thereof) to present a plurality of symbol-bearing reels, an array of symbol positions, and a bonus-triggering persistent element (e.g., a coin pot). Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. Alternatively, the symbol positions may be arranged in a honeycomb configuration with adjacent columns vertically offset from each other by one-half symbol position or adjacent rows horizontally offset from each other by one-half symbol position. The number of symbol positions in different rows and/or different columns may vary from each other. The reels may be associated with the respective columns of the array such that the reels spin vertically and each reel populates a respective column. In another embodiment, the reels may be associated with the respective rows of the array such that the reels spin horizontally and each reel populates a respective row. In some embodiments, the reels are associated with respective individual symbol positions of the array such that each reel animates in place and populates only its respective symbol position. The symbol array configuration may vary between the base game and any bonus games utilizing the array.

In FIG. 4, the symbol array 210 in the base game has a three-by-five rectangular configuration, and each symbol position is associated with a respective independent reel. The reels bear a plurality of symbols that may, for example, include royal symbols 10, J, Q, K, and A; a wild symbol W that can substitute for any of the royal symbols; and generic coin symbols C.

At step 104, the game-logic circuitry detects, via a value input device, a physical item associated with a monetary value that establishes a monetary balance in the form of cash or credits. In FIGS. 4-7, the monetary balance may be shown on a meter 200 akin to the meter 34 in FIG. 1.

At step 106, the game-logic circuitry initiates a base game of a wagering game cycle (i.e., spin cycle) in response to an input indicative of a wager covered by the monetary balance. To initiate a spin of the reels, the player may press a “Spin” or “Max Bet” key on a button panel or touch screen. In FIGS. 4-7, the wager may be shown on a bet meter 202.

At step 108, using an RNG, the game-logic circuitry spins and stops the reels to randomly land symbols from the reels in the array in visual association with one or more paylines (also known as lines, ways, patterns, or arrangements). The reel spin may be animated on a video display by depicting symbol-bearing strips moving vertically across the display and synchronously updating the symbols visible on each strip as the strip moves across the display. Alternatively, the reels may be physical/electromechanical reels. FIG. 4 depicts a base-game spin outcome.

At step 110, the game-logic circuitry awards standard payouts in accordance with a pay table. The pay table may, for example, include “line pays” and “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. To animate a standard pay, the display may apply a border, pattern, color change, background change, watermark, or other distinguishing characteristic to the winning payline and/or winning symbols that contributed to the pay. FIG. 4, for example, depicts a line pay of three K symbols in the bottom row of the array 210. The awarded pay is added to a win meter 204.

At step 112, the game-logic circuitry determines whether or not any coin symbols C landed in the array. If a coin symbol C did not land in the array, the game-logic circuitry immediately proceeds to step 118. If, however, one or more coin symbols C landed in the array as shown in FIG. 4, the game-logic circuitry first proceeds to steps 114 and 116. At step 114, the game-logic circuitry animates the addition of each coin symbol C to a persistent element such as a coin pot above the array. For example, the coin symbol C may fly off the array and land in the coin pot. To represent the addition of the coin symbol to the coin pot, the pot and/or the volume of coins therein may appear to grow in size. In FIG. 4, the transfer of the coin symbol C to the coin pot 212 is represented by an arrow. The persistent element may take forms other than the coin pot 212, including for example an urn, vase, jar, jug, can, bowl, piggy bank, bee hive, ladder, dial, meter, etc. At step 116, using the RNG, the game-logic circuitry randomly determines whether or not to trigger a bonus associated with the coin pot. This random determination is preferably independent of any prior wagering game cycles. However, during a player's gaming session, the growth in size of the coin pot 212 in FIG. 4 may persist from one wagering game cycle to the next such that the player perceives that the bonus may be getting closer to being triggered. If the bonus was not triggered, the game-logic circuitry proceeds to step 118. If, however, the bonus was triggered, the game-logic circuitry first proceeds to the flow in FIG. 3B and conducts a spin-hold-match bonus game.

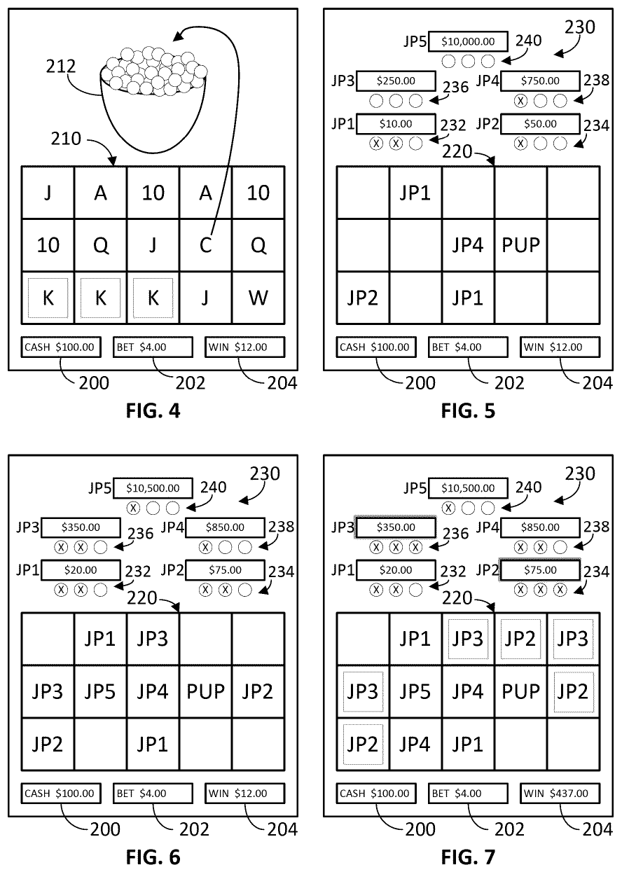

To conduct the bonus game, at step 120 the game-logic circuitry controls one or more presentation devices (e.g., mechanical-reel display device, video display device, or a combination thereof) to present a bonus game array and a prize board. The bonus game array may have the same configuration as the base game array or may have a different configuration than the base game array. In FIGS. 5-7, the bonus game array 220 has the same configuration as the base game array. The symbol positions of the array are initially vacant, i.e., not populated by any symbols. The prize board 230 includes a plurality of fixed or progressive jackpot prize regions JP1, JP2, JP3, JP4, and JP5. The prizes may vary in value with JP1 generally having the lowest value and JP5 generally having the highest value. Below the prize regions JP1, JP2, JP3, JP4, and JP5 are respective collection registers 232, 234, 236, 238, and 240. Each collection register includes a plurality of spots such as three spots. The function of these registers is described below.

At step 122 of the bonus game, using an RNG, the game-logic circuitry spins and stops symbol-bearing bonus reels to randomly land symbols from the reels in the bonus game array. Each symbol position of the array may be associated with a respective independent reel. The reels bear a plurality of bonus symbols that may, for example, include blanks (i.e., no indicia); prize symbols JP1, JP2, JP3, JP4, and JP5; and an upgrade symbol PUP. In FIGS. 5-7, the prize symbols JP1, JP2, JP3, JP4, and JP5 on the reels are associated with the respective prize regions JP1, JP2, JP3, JP4, and JP5 of the prize board 230. The reel spin may be animated on a video display by depicting symbol-bearing strips moving vertically across the display and synchronously updating the symbols visible on each strip as the strip moves across the display. Alternatively, the bonus reels may be physical/electromechanical reels. FIG. 5 depicts an outcome of a first reel spin of the bonus game.

At step 124, for each upgrade symbol PUP that landed in the bonus array, the game-logic circuitry boosts or upgrades the values of one or more of the prizes on the prize board. Which prizes are upgraded, and the amount of each upgrade, may be randomly determined. In FIG. 5, the landed symbols include the upgrade symbol PUP and, as shown in FIG. 6, all five prizes on the prize board 230 were upgraded.

At step 126, for each prize symbol that landed in the bonus array, the game-logic circuitry updates the register associated with that prize symbol by marking an empty spot in the register with, for example, an X, check mark, or copy of that prize symbol. In FIG. 5, the landed symbols include two JP1 symbols, one JP2 symbol, and one JP4 symbol and, thus, the registers 232, 234, and 238 receive two, one, and one marks, respectively.

At step 128, the game-logic circuitry determines whether or not any of the registers is filled with three marks, thus denoting a match of three prize symbols associated with the filled register(s). If any of the registers is filled, the game-logic circuitry proceeds to step 130 where it awards the prize(s) associated with the filled register(s) and then returns to step 118 in FIG. 3A. If, however, none of the registers is filled with three marks, at step 132 the game-logic circuitry holds or locks any landed prize and upgrade symbols in place in the bonus game array and maintains the current state of the registers (i.e., maintains any marks in the registers). The game-logic circuitry then returns to step 122 to spin and stop the bonus reels associated with any remaining vacant positions in the array (i.e., positions that do not contain the locked prize and upgrade symbols), thereby repeating the flow in FIG. 3B until the game-logic circuitry determines, at step 128, that one or more of the registers is filled with three marks and awards, at step 130, the prize(s) associated with the filled register(s).

FIGS. 5 through 7 are exemplary presentations of bonus-game spin outcomes and prize board updates resulting from the flow in FIG. 3B. As described above, FIG. 5 depicts a first spin outcome comprising an upgrade symbol PUP, two JP1 symbols, one JP2 symbol, and one JP4 symbol. In response to the upgrade symbol PUP, the values of the prizes on the prize board 230 are increased to the values shown in FIG. 6. In response to the two JP1 symbols, one JP2 symbol, and one JP4 symbol, the registers 232, 234, and 238 receive two, one, and one marks, respectively. None of the registers is filled with three marks so the bonus game continues without awarding any prizes from the prize board 230.

FIG. 6 depicts a second spin outcome that, in addition to the prize and PUP symbols from FIG. 5 held in place, comprises one JP2 symbol, two JP3 symbols, and one JP5 symbol. In response to these additional prize symbols, the registers 234, 236, and 240 receive one, two, and one marks, respectively. None of the registers is filled with three marks so the bonus game continues without awarding any prizes from the prize board 230.

FIG. 7 depicts a third spin outcome that, in addition to the prize and PUP symbols from FIGS. 5 and 6 held in place, comprises one JP2 symbol, one JP3 symbol, and one JP4 symbol. In response to these additional prize symbols, the registers 234, 236, and 238 each receive one mark. The registers 234 and 236 are each filled with three marks. Thus, the prizes JP2 and JP3 associated with those registers 234 and 236 are added to the win meter 204 and then the bonus game ends.

At step 118, the game-logic circuitry determines whether or not it has received a cashout input via at least one of the one or more player input devices of the gaming machine. If it has not received a cashout input, the game-logic circuitry waits for the next wager input at step 106. If it has received a cashout input, the game-logic circuitry initiates a payout from the monetary balance on the meter 200 in FIGS. 4-7. The data processing method then ends at step 134.

Embodiments of the present invention realize benefits in increased computer processing efficiency with minimized processing overhead, fewer rules to be evaluated, fewer player inputs to be monitored, and simpler graphical representations. With respect to the bonus-triggering process, the game-logic circuitry need only make a random determination as to whether the bonus is triggered when a coin symbol C appears in the array and is transferred to a coin pot during a wagering cycle. If the coin symbol C does not appear in the array, the game-logic circuitry foregoes such a random determination. In contrast, in typical prior art systems with mystery bonus triggers, the game-logic circuitry makes a random determination in each and every wagering game cycle, thereby reducing processing efficiency.

With respect to the bonus game itself, as prize and upgrade symbols land and are held in the bonus game array, the game-logic circuitry need only respin those reels associated with any remaining vacant positions in the array. This minimizes the contribution of reels spins to processing overhead. And because the game-logic circuitry need only evaluates the bonus game array for completed matches of prize symbols, the computing resources for conducting the bonus game itself are minimized. In stark contrast, in typical free spin bonuses, overlapping payline sections require multiple evaluation steps. Often, analysis is required to determine which payline results in the highest credit total, with the lesser value paylines being discarded but only after being evaluated—all this adds to processing overhead. Special symbols like wilds, multipliers, and scatter symbols can modify paytable values and may require separate, additional evaluation according to customized rule sets. All these procedures can be inherently more complex than the bonus game embodiments disclosed herein. The embodiments disclosed herein involve simple collection of different prize symbols until a match(es) occurs and a prize award associated with each match. This represents a win-win: simpler, almost self-explanatory graphics combined with faster, more efficient processing.

Further, the spin-hold-match feature requires minimal or no inputs from a player, thereby minimizing computing resources devoted to detecting player inputs and expediting play of the bonus game. In contrast, prior art systems with typical pick-until-you-match features require the game-logic circuitry to detect a series of player selections of different icons and to reveal symbols associated with the selected icons, thus using more computing resources.

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system comprising:
a gaming cabinet;
a presentation assembly;
a value input device configured to receive a physical item associated with a monetary
value that establishes a monetary balance;
a value output device configured to dispense a payout from the monetary balance; and
game-logic circuitry secured within a locked box inside the gaming cabinet, the game-logic circuitry including memory storing programming for a random number generator (RNG) and a wagering game including a base game and a bonus game, the game-logic circuitry configured to cause the gaming system to perform operations to:
prior to executing the wagering game, execute an authentication program on the gaming system to authenticate at least the RNG programming and wagering-game programming that determines game outcomes, wherein executing the authentication program comprises generating a live authentication code derived from contents of the memory and comparing the live authentication code to a trusted code stored in the memory, and permit execution of the RNG programming and the wagering-game programming only upon a match;
conduct a plurality of wagering game cycles of the base game, the base game including:
directing the presentation assembly to present a plurality of symbol-bearing base reels, a base array, and a persistent element;
maintaining, in the memory, a persistent-element state record that represents a current state of the persistent element and that is preserved in the memory from one wagering game cycle of the base game to a next wagering game cycle of the base game;
spinning and stopping the plurality of base reels to land symbols from the base reels in the base array;
in response to the landed symbols including a bonus-triggering symbol:
updating the persistent-element state record to reflect addition of the bonus-triggering symbol to the persistent element;
transforming the updated persistent-element state record into animation control signals for the presentation assembly and outputting the animation control signals to the presentation assembly to animate the addition of the bonus-triggering symbol to the persistent element; and
executing the RNG to randomly determine whether to trigger the bonus game; and
in response to the landed symbols not including the bonus-triggering symbol, forgoing execution of the RNG to determine whether to trigger the bonus game; and
in response to triggering the bonus game, conduct the bonus game, including:
directing the presentation assembly to present a plurality of symbol-bearing bonus reels and a bonus array, the plurality of bonus reels bearing a plurality of prize symbols;
maintaining, in the memory, a game-state data record indicative of at least (i) landed prize symbols in the bonus array and (ii) which positions of the bonus array are held and which are vacant;
updating, based on a randomly-determined outcome of each bonus-game spin, the game-state data record to reflect newly landed prize symbols and the current state of which positions of the bonus array are held and which are vacant;
transforming the updated game-state data record into animation control signals for the presentation assembly;
outputting the animation control signals to the presentation assembly to animate spinning and stopping only those bonus reels associated with vacant positions of the bonus array while maintaining the landed prize symbols in their positions; and
awarding one or more prizes based on the landed prize symbols.

2. The gaming system of claim 1, wherein the persistent element comprises a coin pot, and wherein the bonus-triggering symbol comprises a coin symbol.

3. The gaming system of claim 1, wherein the game-logic circuitry is further configured to cause the gaming system to perform operations to randomly determine, independent of any prior wagering game cycle, whether to trigger the bonus game upon executing the RNG.

4. The gaming system of claim 1, wherein animating the addition of the bonus-triggering symbol to the persistent element includes increasing a displayed size of the persistent element or a displayed volume of items therein.

5. The gaming system of claim 1, wherein the plurality of bonus reels bears an upgrade symbol, and wherein the game-logic circuitry is further configured to cause the gaming system to perform operations to, in response to the upgrade symbol landing in the bonus array, randomly select one or more prizes associated with the bonus game and randomly determine a magnitude by which to upgrade each randomly-selected prize.

6. The gaming system of claim 1, wherein the bonus game further comprises:
a prize board comprising a plurality of prizes and a plurality of collection registers associated with the respective prizes, each prize symbol of the plurality of prize symbols associated with a respective one of the prizes;
wherein the game-state data record is further indicative of a current state of each collection register;
wherein updating the game-state data record further comprises updating the current state of each collection register based on the newly landed prize symbols; and
wherein awarding the one or more prizes based on the landed prize symbols comprises, in response to any of the collection registers being filled, awarding the prizes associated with the filled collection registers.

7. The gaming system of claim 6, wherein each collection register includes a predetermined number of spots, and wherein each collection register is filled when the predetermined number of prize symbols associated with the corresponding prize have landed in the bonus array across one or more bonus-game spins.

8. The gaming system of claim 1, wherein the base array and the bonus array have different configurations.

9. The gaming system of claim 1, wherein the plurality of base reels and the plurality of bonus reels are electromechanical reels, and wherein the plurality of base reels are associated with respective columns of the base array.

10. The gaming system of claim 1, wherein the gaming system is regulatorily approved and primarily dedicated to playing a wagering game.

11. A method of operating a gaming system that includes a gaming cabinet, a presentation assembly, and game-logic circuitry secured within a locked box inside the gaming cabinet, the game-logic circuitry including memory storing programming for a random number generator (RNG) and a wagering game including a base game and a bonus game, the method comprising the operations of:
prior to executing the wagering game, executing, by the game-logic circuitry, an authentication program on the gaming system to authenticate at least the RNG programming and wagering-game programming that determines game outcomes, wherein executing the authentication program comprises generating a live authentication code derived from contents of the memory and comparing the live authentication code to a trusted code stored in the memory, and permitting execution of the RNG programming and the wagering-game programming only upon a match;
conducting, by the game-logic circuitry, a plurality of wagering game cycles of the base game, the base game including:
directing the presentation assembly to present a plurality of symbol-bearing base reels, a base array, and a persistent element;
maintaining, in the memory, a persistent-element state record that represents a current state of the persistent element and that is preserved in the memory from one wagering game cycle of the base game to a next wagering game cycle of the base game;
spinning and stopping the plurality of base reels to land symbols from the base reels in the base array;
in response to the landed symbols including a bonus-triggering symbol:
updating the persistent-element state record to reflect addition of the bonus-triggering symbol to the persistent element;
transforming the updated persistent-element state record into animation control signals for the presentation assembly and outputting the animation control signals to the presentation assembly to animate the addition of the bonus-triggering symbol to the persistent element; and
executing the RNG to randomly determine whether to trigger the bonus game; and
in response to the landed symbols not including the bonus-triggering symbol, forgoing execution of the RNG to determine whether to trigger the bonus game; and
in response to triggering the bonus game, conducting, by the game-logic circuitry, the bonus game, including:
directing the presentation assembly to present a plurality of symbol-bearing bonus reels and a bonus array, the plurality of bonus reels bearing a plurality of prize symbols;
maintaining, in the memory, a game-state data record indicative of at least (i) landed prize symbols in the bonus array and (ii) which positions of the bonus array are held and which are vacant;
updating, based on a randomly-determined outcome of each bonus-game spin, the game-state data record to reflect newly landed prize symbols and the current state of which positions of the bonus array are held and which are vacant;
transforming the updated game-state data record into animation control signals for the presentation assembly;
outputting the animation control signals to the presentation assembly to animate spinning and stopping only those bonus reels associated with vacant positions of the bonus array while maintaining the landed prize symbols in their positions; and
awarding one or more prizes based on the landed prize symbols.

12. The method of claim 11, wherein the persistent element comprises a coin pot, and wherein the bonus-triggering symbol comprises a coin symbol.

13. The method of claim 11, wherein randomly determining whether to trigger the bonus game is performed independent of any prior wagering game cycle.

14. The method of claim 11, wherein animating the addition of the bonus-triggering symbol to the persistent element includes increasing a displayed size of the persistent element or a displayed volume of items therein.

15. The method of claim 11, wherein the plurality of bonus reels bears an upgrade symbol, the method further comprising, in response to the upgrade symbol landing in the bonus array, randomly selecting one or more prizes associated with the bonus game and randomly determining a magnitude by which to upgrade each randomly-selected prize.

16. The method of claim 11, wherein conducting the bonus game further comprises:
directing the presentation assembly to further present a prize board comprising a plurality of prizes and a plurality of collection registers associated with the respective prizes, each prize symbol of the plurality of prize symbols associated with a respective one of the prizes;
wherein the game-state data record is further indicative of a current state of each collection register;
wherein updating the game-state data record further comprises updating the current state of each collection register based on the newly landed prize symbols; and
wherein awarding the one or more prizes based on the landed prize symbols comprises, in response to any of the collection registers being filled, awarding the prizes associated with the filled collection registers.

17. The method of claim 16, wherein each collection register includes a predetermined number of spots, and wherein each collection register is filled when the predetermined number of prize symbols associated with the corresponding prize have landed in the bonus array across one or more bonus-game spins.

18. The method of claim 11, wherein the base array and the bonus array have different configurations.

19. The method of claim 11, wherein the plurality of base reels and the plurality of bonus reels are electromechanical reels, and wherein the plurality of base reels are associated with respective columns of the base array.

20. The method of claim 11, wherein the gaming system is regulatorily approved and primarily dedicated to playing a wagering game, the method further comprising the operations of:
receiving, via a value input device, a physical item associated with a monetary value that establishes a monetary balance; and
dispensing, via a value output device, a payout from the monetary balance.
